(19) United States
(12) Patent Application Publication
(10) Pub. No.: US 2018/0139540 A1
(43) Pub. Date: May 17, 2018

(54) DEEP-DRAWN FOIL-BASED MINIATURE DIAPHRAGM ASSEMBLY

(71) Applicant: Ole Wolff Elektronik A/S, Sorø (DK)

(72) Inventors: Morten Kjeldsen Andersen, Odder (DK); Palle Torben Sørensen, Sorø (DK)

(21) Appl. No.: 15/569,049

(22) PCT Filed: Apr. 27, 2016
(86) PCT No.: PCT/EP2016/059402

§ 371 Date: Oct. 24, 2017

(30) Foreign Application Priority Data
Apr. 30, 2015 (EP) 15165919.0

(51) Int. Cl. H04R 9/06; H04R 7/18; H04R 7/12; H04R 9/02; H04R 31/00; B32B 27/08; B32B 27/28; B32B 27/40

(52) U.S. Cl. CPC H04R 9/06; H04R 7/18; H04R 7/122; H04R 9/025; H04R 31/003; B29C 51/082; B32B 27/285; B32B 27/40; H04R 2499/11; H04R 2307/025; B32B 27/08

(57) ABSTRACT

A miniature diaphragm assembly including a deep-drawn polymer foil forming a moveable membrane having an integrated suspension member and an integrated attachment region for attaching the diaphragm assembly to an outer surface of an associated receiver arrangement, said attachment region extending in a direction being essentially parallel to a direction of movement of the movable membrane.

### FIELD OF THE INVENTION

The present invention relates to a deep-drawn foil-based diaphragm assembly for miniature receivers/transducers. In particular, the present invention relates to a deep-drawn foil-based miniature diaphragm assembly being manufactured with the purpose of maximizing the achievable sound pressure level.

### BACKGROUND OF THE INVENTION

Various attempts are constantly being applied in order to optimize the performance of miniature electroacoustic receivers.

As an example WO 02/065813 A2 relates to an electroacoustic receiver having a stationary receiver part and a membrane arrangement comprising a deep-drawn foil membrane and a handling ring attached thereto. The membrane arrangement is connected to the stationary receiver part via the handling ring in that the handling ring and the membrane are mutually connected via a so-called interlocking connection.

The membrane arrangement suggested in WO 02/065813 A2 is attached to the stationary receiver part in a manner so that the active area of the deep-drawn membrane is significantly reduced. As a result the achievable sound pressure level (SPL) is reduced accordingly. The arrangement suggested in WO 2004/017672 A1 also suffers from a reduced SPL due to a non-optimized membrane area.

It may be seen as an object of embodiments of the present invention to provide a membrane layout which enhances the acoustical performance of miniature electroacoustic receivers.

It may be seen as a further object of embodiments of the present invention to provide a membrane layout which enhances SPL of miniature electroacoustic receivers.

### DESCRIPTION OF THE INVENTION

The above-mentioned objects are complied with by providing, in a first aspect, a miniature diaphragm assembly comprising a deep-drawn polymer foil forming a moveable membrane having an integrated suspension member and an integrated attachment region for attaching the diaphragm assembly to an outer surface of an associated receiver arrangement, said attachment region extending in a direction being essentially parallel to a direction of movement of the moveable membrane.

The direction of extension of the attachment region may alternatively be expressed as if the attachment region extends in a direction being essentially perpendicular to the direction of extension of the membrane.

Thus, the present invention relates to a diaphragm assembly being formed using a deep-drawing manufacturing process. In this manufacturing process a polymer foil, which may be a laminated polymer foil, may be exposed to elevated temperatures and a controlled air pressure punch.

As stated the diaphragm assembly is adapted to be attached to an outer surface of an associated receiver arrangement. The fact that the diaphragm assembly is to be attached to an outer surface of an associated receiver arrangement is advantageous in that this increases the achievable active membrane area, and thereby the achievable SPL, to a maximum. The outer surface of the associated receiver arrangement may include outer surfaces of a receiver housing, outer surfaces of a receiver frame, outer surfaces of a receiver yoke etc.

The direction of movement of the movable membrane is to be understood as the direction of movement of the moveable membrane during operation, i.e. during generation of sound, when the diaphragm assembly is attached to an associated receiver.

The diaphragm assembly comprises a moveable membrane, an integrated suspension member and an integrated attachment region. By integrated is meant that the membrane, the suspension member and the attachment region are formed using a single polymer foil.

The membrane may extend primarily in one direction, said direction being essentially perpendicular to the direction of movement of the membrane. The integrated attachment region primarily extends in a direction being essentially parallel to the intended direction of movement of the membrane, i.e. in a direction being essentially perpendicular to the primary direction of extension of the membrane.

The orientation of the integrated attachment region is advantageous in that it allows that the active area of the membrane can be maximized whereby the achievable SPL is optimized as well.

As already addressed the deep-drawn polymer foil may comprise a laminated foil structure. In principle the number of foils being laminated together may be any number, such as 2, 3, 4, 5 or even more foils.

In an embodiment of the present invention the miniature diaphragm assembly comprises a laminated foil structure comprising a polyetheretherketone (PEEK) foil and a polyurethane (PU) foil being laminated together. In this embodiment the PEEK foil may have a thickness in the range of 1-10 μm, such as in the range of 2-8 μm, such as in the range of 2-6 μm, such as in the range of 2-4 μm, such as around 3 μm. The PU foil may have a thickness in the range of 4-40 μm, such as in the range of 6-30 μm, such as in the range of 8-20, such as in the range of 10-15 μm, such as around 12 μm.

The diaphragm assembly according to the present invention may have an outer diameter being smaller than 15 mm, such as smaller than 14 mm, such as smaller than 12 mm, such as smaller than 10 mm, such as in the range 3-8 mm. Also, the diaphragm assembly may have a fundamental resonance frequency below 1000 Hz, such as below 800 Hz, such as around 500 Hz.

In a second aspect the present invention relates to a miniature receiver comprising a diaphragm assembly according to the first aspect. The miniature receiver may further comprise a voice coil attached to the deep-drawn polymer foil, said voice coil being at least partly positioned in an air gap of a magnetic circuit.

In a third aspect the present invention relates to a hearing aid instrument comprising a miniature receiver according to the second aspect.

In a fourth aspect the present invention relates to a mobile device comprising a miniature receiver according to the second aspect, said mobile device being selected from the group consisting of: personal communication devices, such as mobile phones, tablets, laptops etc., or personal sound amplifiers.

In a fifth aspect the present invention relates to a method for manufacturing a miniature diaphragm assembly, the method comprising the steps of
a) providing a laminated foil structure,
b) positioning the laminated foil structure between a top and a bottom deep-drawing tooling arrangement, wherein surface contours of the bottom arrangement defines the layout of the miniature diaphragm,
c) applying an air pressure punch in a region between the top tooling arrangement and the laminated foil structure so that the laminated foil structure is pressed against the surface contours of the bottom deep-drawing tooling arrangement, and
d) releasing the deep-drawn laminated foil structure and the handling structure from the bottom deep-drawing tooling arrangement.

The laminated foil structure may comprise a PEEK foil and a PU foil. The PEEK foil may have a thickness in the range of 1-10 μm, such as in the range of 2-8 μm, such as in the range of 2-6 μm, such as in the range of 2-4 μm, such as around 3 μm. The PU foil may have a thickness in the range of 4-40 μm, such as in the range of 6-30 μm, such as in the range of 8-20, such as in the range of 10-15 μm, such as around 12 μm.

The miniature diaphragm assembly may, in case of a circular shape, have an outer diameter being smaller than 15 mm, such as smaller than 14 mm, such as smaller than 12 mm, such as smaller than 10 mm, such as in the range 3-8 mm. The applied air pressure punch may have a pressure in the range 1-5 kg/cm², such as around 4 kg/cm².

The method according to the fifth aspect of the present invention may further comprise a step of attaching the deep-drawn laminated foil structure to a handling structure. This may be advantageous in that a handling structure may ease handling of the diaphragm assembly in later process steps, such as when the diaphragm assembly is to be attached to an associated receiver. The shape of the handling structure may be determined by the shape of the diaphragm assembly. Thus, in case of a circular diaphragm assembly the handling structure may advantageously take the shape of a ring-shaped structure.

### BRIEF DESCRIPTION OF THE DRAWINGS

The present invention will now be described in further details with reference to the accompanying figures, wherein

FIG. 1 shows a cross-sectional view of an assembled receiver,

FIG. 2 shows how the diaphragm assembly can be secured to a yoke,

FIG. 3 shows a laminated diaphragm,

FIG. 4 illustrates the manufacturing process of the diaphragm assembly,

FIG. 5 shows how the diaphragm assembly can be secured to a receiver frame, and

FIG. 6 shows how the diaphragm assembly can be secured to the yokes.

While the invention is susceptible to various modifications and alternative forms specific embodiments have been shown by way of examples in the drawings and will be described in details herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

In its broadest aspect the present invention relates to a diaphragm assembly having a membrane layout which enhances the acoustical performance of miniature electroacoustic receivers. In particular, the present invention tends to maximize the active area of the membrane in order to achieve the highest available SPL.

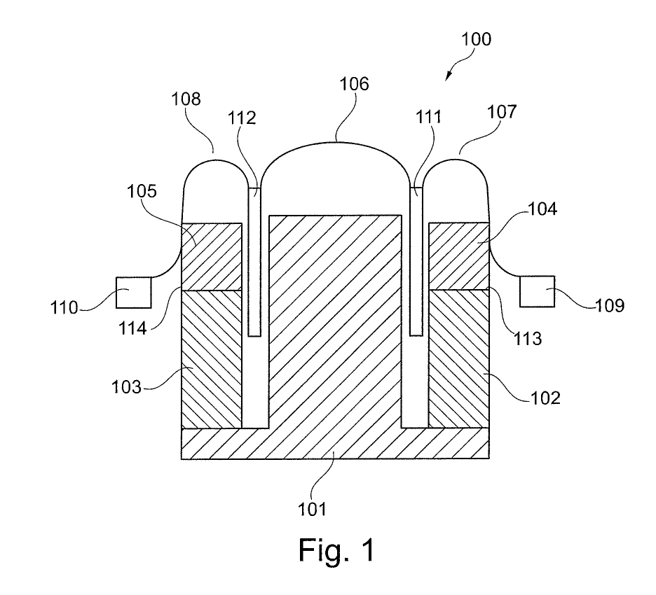

Referring now to FIG. 1 a cross-sectional view of an assembled motor assembly and diaphragm assembly 100 according to the present invention is depicted. The motor assembly itself comprises an inner yoke 101, and at least one outer yoke 104, 105. The number of outer yokes 104, 105 depends on the shape of the assembly. For example, an essential circular assembly will have one outer yoke whereas a rectangular assemble will have at least two outer yokes. The magnetic flux is driven by at least one permanent magnet 102, 103. Again, the number of permanent magnets 102, 103 will depend on the shape of the assembly. The diaphragm assembly comprises an active area 106 in the form of a moveable membrane being suspended in suspension members 107, 108. The active area 106 may have integrated stiffeners in order to increase the acoustical performance.

A voice coil shown as sections 111, 112 is secured to the diaphragm assembly. The voice coil extends into the air gap between the inner yoke 101 and the respective outer yokes 104, 105. A handling structure 109, 110 is attached to the lower side of the diaphragm assembly in order to ease handling and mounting of the diaphragm assembly to the motor assembly. It should be noted however, that the handling structure 109, 110 could alternatively be attached to the upper side of the diaphragm assembly.

The motor assembly may in principle take any shape. In case of an essential circular motor assembly the typical diameter of the motor assembly may be in the range 3-15 mm, such as between 3.6 mm and 8 mm.

As it will be explained later the diaphragm assembly may be manufactured using a deep-drawing process. The membrane and the integrated suspension member of the diaphragm assembly are preferably constituted by a laminated foil structure. The number of applied foil layers may be chosen in respect of the required demands.

As depicted in FIG. 1 the suspension members 107, 108 are secured to the respective outer surfaces 113, 114 of the outer yokes 104, 105. In particular, the suspension members 107, 108 are secured to upper portions as well as outer surfaces of the outer yokes 104, 105. By following this approach the effective active area of the membrane can be maximized in order to maximize the SPL accordingly. The increased effective area of the membrane may enhance the SPL with up to 4 dB compared to conventional mounting schemes.

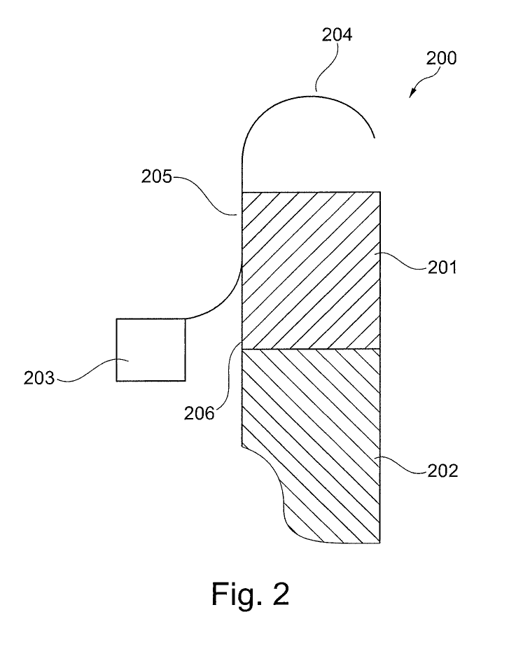

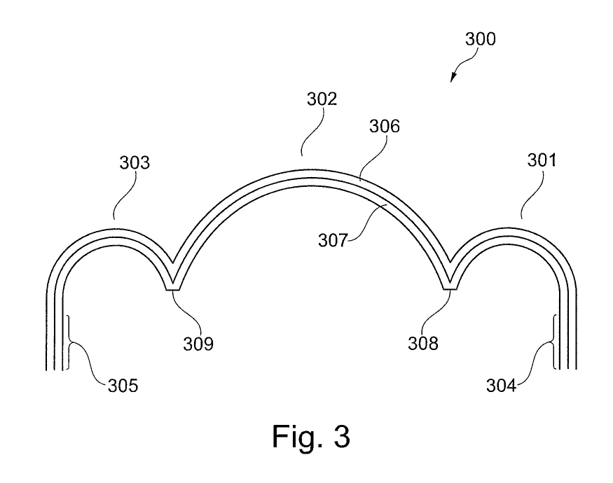

FIG. 2 shows an enlarged view of the attachment of the suspension member 204 to the outer surface 206 of the outer yoke 201 in the region being denoted 205. The suspension member 204 is secured to the outer surface 206 of the outer yoke 201 using a suitable fixation means such as gluing, welding etc. The correct vertical position of the suspension member 204 relative to the outer yoke 201, i.e. the height/size of the region 205, can be adjusted by positioning the handling structure 203 on a support or rest structure (not shown) which has a fixed spatial position relative to the motor assembly. In this way the height/size of the attachment region 205 can be reproduced in an easy way. Again, the handling structure 203 may alternatively be attached to the upper side of the diaphragm assembly. FIG. 3 shows a cross-sectional view of a diaphragm assembly 300. As seen in FIG. 3, the diaphragm assembly 300 is constituted by a laminated structure having an upper 306 and a lower 307 layer. In an embodiment of the present invention the upper layer 306 is formed by a 3 μm PEEK foil, whereas the lower layer 307 is formed by a 12 μm PU foil. The 12 μm PU foil ensures high compliance and a fundamental resonance frequency in the 300-700 Hz range, such as around 500 Hz. It should be noted however, that other thicknesses and materials may be applicable as well.

As seen in FIG. 3 the diaphragm assembly 300 comprises an active moveable membrane area 302 as well as two suspensions members 301, 303. FIG. 3 further depicts the attachments regions 304, 305 for securing the diaphragm assembly 300 to the outer surfaces of either the outer yokes or an outer frame structure of the motor assembly (not shown). As already addressed in connection with FIG. 1 a voice coil (not shown) is to be secured to the regions 308, 309 using appropriate fixation means. Typically, the mass of the voice coil may be in the range of 5-10 mg.

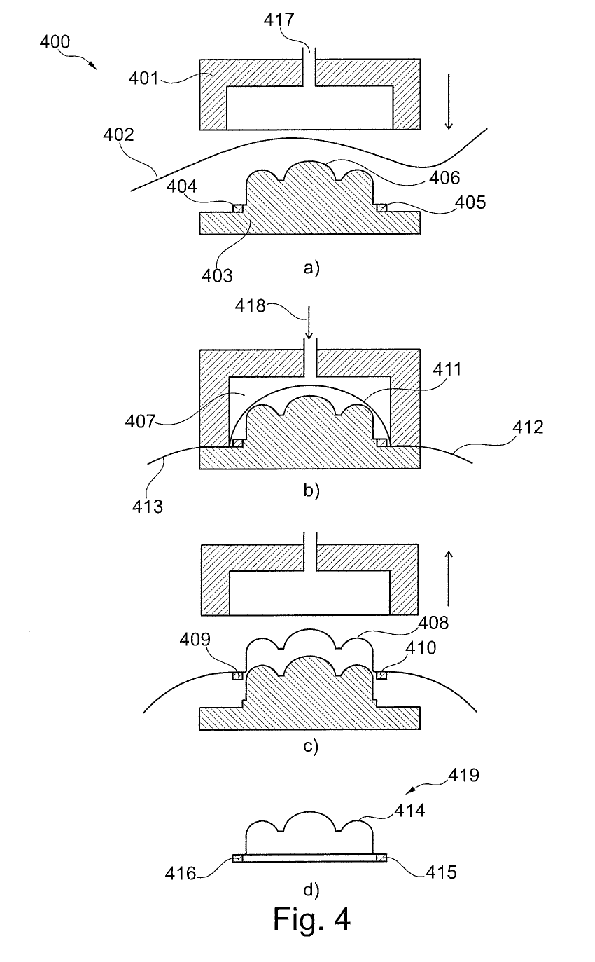

FIG. 4 illustrates how the diaphragm assembly is manufactured using a deep-drawing process 400.

Firstly, a foil structure 402, such as a laminated foil structure, is positioned between a top tooling arrangement 401 and a bottom 403 tooling arrangement. The top tooling arrangement 401 has an air inlet 417. The surface contour 406 of the bottom tooling arrangement 403 defines the desired layout of the miniature diaphragm assembly. A handling structure 404, 405 to be attached to the foil structure 402 is provided at the surface of the bottom tooling arrangement 403, cf. FIG. 4a. Alternatively, the handling structure 404, 405 may be attached to the foil structure 402 beforehand, i.e. attached to the foil structure 402 before the foil structure 402 is positioned between the top tooling arrangement 401 and the bottom 403 tooling arrangement.

Secondly, when the top and bottom tooling arrangements 401, 403 have been brought together as illustrated in FIG. 4b an air pressure punch of around 4 kg/cm² is applied in a region 407 between the top tooling arrangement and the foil structure 411. The air pressure punch is provided by providing pressurized air 418 to the region 407. As a result of this air pressure punch the foil structure 411 is pressed against the surface contour of the bottom tooling arrangement. The duration of the air pressure punch is typically around 3-5 minutes. During this period the foil structure is heated to elevated temperatures. Excess foil structure portions 412, 413 are to be removed later. As a result of the applied air pressure punch and the elevated temperature the surface contour of the bottom tooling arrangement defines the shape of the miniature diaphragm assembly. The foil structure is furthermore attached to the handling structure using appropriate fixation means, unless the handling structure is attached to the foil structure beforehand. As previously mentioned the foil structure may be a laminated foil structure. In FIG. 4c the foil structure 408 and the handling structure 409, 410 attached thereto are released from the bottom tooling arrangement. As previously addressed the handling structure 409, 410 eases the handling and mounting of the diaphragm assembly. In FIG. 4c the handling structure 409, 410 is positioned below the foil structure 408. It should be noted however that the handling structure could equally be positioned on the opposite side of the foil structure 408.

FIG. 4d shows the final diaphragm assembly 419 comprising a foil structure 414 secured to a handling structure 415, 416. Excess foil structure portions have been removed using for example laser cutting or other appropriate techniques.

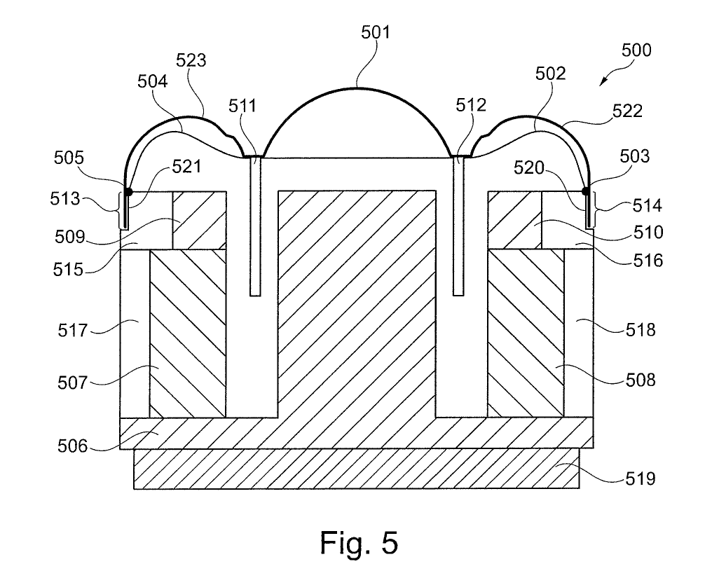

Referring now to FIG. 5 a complete miniature receiver 500 is depicted. The receiver comprises a motor assembly including an inner yoke 506, an outer yoke 509, 510 and a permanent magnet 507, 508. The inner yoke 506 is arranged on a base 519. The diaphragm assembly comprises an active moveable membrane area 501 surrounded by a suspension member 522, 523. The diaphragm assembly further comprises attachment regions 513, 514. A voice coil 511, 512 is attached to the diaphragm and electrically connected to the surroundings via lead-out wires 502, 504 which are connectable via connection points 503, 505, respectively. The diaphragm is attached via its attachment regions 513, 514 to the respective outer surfaces 520, 521 of the receiver frame 515, 516 so that the active area of the membrane and thereby the achievable SPL of receiver is maximized. As seen in FIG. 5 the outer yoke surfaces 520, 521 to which surfaces the diaphragm assembly is attached are arranged in respective recesses of the receiver frame 515, 516. The arrangement allows that a receiver cap may be attached to the receiver frame 515, 516 and/or the additional receiver frame 517, 518 without scratching or damaging the diaphragm assembly in the attachment regions 513, 514. The additional receiver frame 517, 518 is arranged on the outside of the permanent magnets 507, 508.

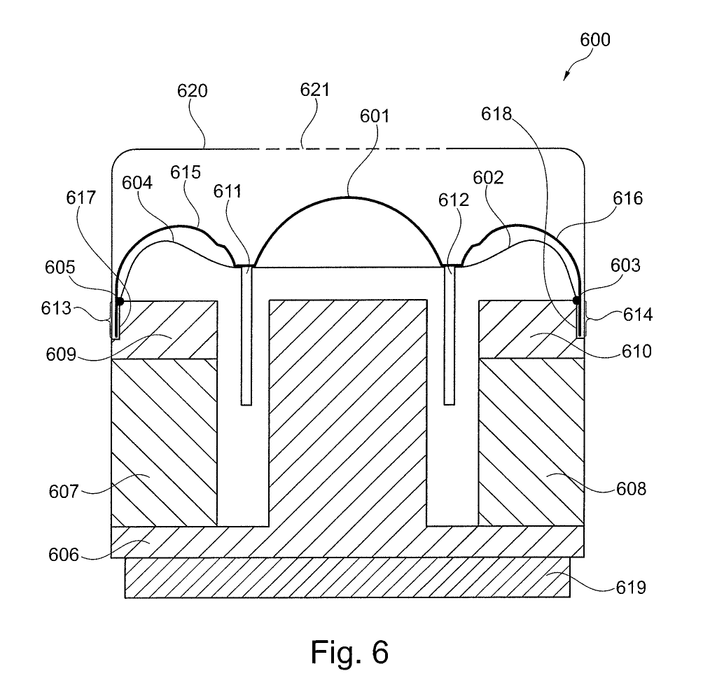

FIG. 6 also shows a complete miniature receiver 600. Compared to the embodiment shown in FIG. 5 the receiver shown in FIG. 6 comprises a receiver cap 620 with sound outlet openings 621 arranged therein. The receiver cap 602 is provided for protecting the receiver, in particular protecting the diaphragm assembly. In contrast to the receiver shown in FIG. 5 the receiver shown in FIG. 6 has no receiver frame. Instead the diaphragm assembly is attached directly to the respective outer surfaces 617, 618 of the outer yoke 609, 610. The receiver further comprises a motor assembly including an inner yoke 606, an outer yoke 609, 610 and a permanent magnet 607, 608. The inner yoke 606 is arranged on a base 619. The diaphragm assembly comprises an active moveable membrane area 601 surrounded by a suspension member 615, 616. The diaphragm assembly further comprises attachment regions 613, 614. A voice coil 611, 612 is attached to the diaphragm and electrically connected to the surroundings via lead-out wires 602, 604 which are connectable via connection points 603, 605, respectively. As already addressed the diaphragm is attached via its attachment regions 613, 614 to the respective outer surfaces 617, 618 of the outer yoke 609, 610 so that the active area of the membrane and thereby the achievable SPL of receiver is maximized. As seen in FIG. 6 the outer yoke surfaces 617, 618 to which surfaces the diaphragm assembly are attached are arranged in respective recesses of the outer yoke 609, 610. The arrangement allows that the receiver cap 620 may be attached to the outer yoke 609, 610 and/or the permanent magnet 607, 608 without scratching or damaging the diaphragm assembly in the attachment regions 613, 614.

1. A miniature diaphragm assembly comprising a deep-drawn polymer foil forming a moveable membrane having an integrated suspension member and an integrated attachment region for attaching the diaphragm assembly to an outer surface of an associated receiver arrangement, said attachment region extending in a direction being essentially parallel to a direction of movement of the movable membrane.

2. A miniature diaphragm assembly according to claim 1, wherein the deep-drawn polymer foil comprises a laminated foil structure.

3. A miniature diaphragm assembly according to claim 2, wherein the laminated foil structure comprises a polyetheretherketone foil and a polyurethane foil laminated together.

4. A miniature diaphragm assembly according to claim 3, wherein the polyetheretherketone foil has a thickness in the range of 1-10 μm.

5. A miniature diaphragm assembly according to claim 3, wherein the polyurethane foil has a thickness in the range of 4-40 μm.

6. A miniature diaphragm assembly according to claim 1, wherein the diaphragm assembly has an outer diameter being smaller than 15 mm.

7. A miniature diaphragm assembly according to claim 1, wherein the diaphragm assembly has a fundamental resonance frequency below 1000 Hz.

8. A miniature receiver comprising a diaphragm assembly according to claim 1.

9. A miniature receiver according to claim 8, further comprising a voice coil attached to the deep-drawn polymer foil.

10. A miniature receiver according to claim 8, further comprising a magnetic circuit for driving the diaphragm assembly.

11. A hearing aid instrument comprising a miniature receiver according to claim 8.

12. A mobile device comprising a miniature receiver according to claim 8, said mobile device being selected from the group consisting of: personal communication devices including mobile phones, tablets, laptops, or personal sound amplifiers.

13. A method for manufacturing a miniature diaphragm assembly, the method comprising the steps of
a) providing a laminated foil structure,
b) positioning the laminated foil structure between a top and a bottom deep-drawing tooling arrangement, wherein surface contours of the bottom arrangement defines the layout of the miniature diaphragm,
c) applying an air pressure punch in a region between the top tooling arrangement and the laminated foil structure so that the laminated foil structure is pressed against the surface contours of the bottom deep-drawing tooling arrangement, and
d) releasing the deep-drawn laminated foil structure and the handling structure from the bottom deep-drawing tooling arrangement.

14. A method according to claim 13, wherein the laminated foil structure comprises a polyetheretherketone foil and a polyurethane foil.

15. A method according to claim 14, wherein the polyetheretherketone foil has a thickness in the range of 1-10 μm.

16. A method according to claim 14, wherein the polyurethane foil has a thickness in the range of 4-40 μm.

17. A method according to claim 13, wherein the miniature diaphragm assembly has an essentially circular shape and an outer diameter being smaller than 15 mm, such as smaller than 14 mm, such as smaller than 12 mm.

18. A method according to claim 13, wherein the applied air pressure punch has a pressure in the range 1-5 kg/cm².

19. A method according to claim 13, further comprising the step of attaching the deep-drawn laminated foil structure to a handling structure.
